(19) United States
(12) Patent Application Publication
(10) Pub. No.: US 2003/0094341 A1
(43) Pub. Date: May 22, 2003

(54) Shock absorber with a gas chamber on the rebound side of a piston

(76) Inventor: Rene Lemieux, Granby (CA)

Correspondence Address: PILLSBURY WINTHROP, LLP, P.O. BOX 10500, MCLEAN, VA, 22102, US

(21) Appl. No.: 10/282,233

(22) Filed: Oct. 29, 2002

Related U.S. Application Data
(60) Provisional application No. 60/330,727, filed on Oct. 29, 2001.

(51) Int. Cl. F16F 9/00

(52) U.S. Cl. 188/316

(57) ABSTRACT

A shock absorber includes a shock rod, a shock body is disposed around a first end of the shock rod. A piston is disposed on the first end of the shock rod in sealing engagement with the shock body. The piston having at least one channel therethrough in communication with a fluid chamber within the shock body. The piston separating the shock body fluid chamber into a compression fluid chamber and a rebound fluid chamber. A reservoir comprising a gas chamber and a movable sealing surface separates the reservoir gas chamber from the shock body rebound fluid chamber, with which the reservoir is in fluid communication.

This application claims priority to U.S. Application No. 60/330,727, filed Oct. 29, 2001, the entire contents of which are incorporated herein by reference.

### 1. FIELD OF THE INVENTION

The field of the present invention relates to shock absorbers that include a piston and shock rod assembly that move within a fluid-containing shock housing. The piston separates the shock body interior into a compression side and a rebound side. The present invention further relates to shock absorbers that include a gas chamber to accommodate fluid displacement caused by the entry of a shock rod into a shock body. The gas chamber is disposed on the rebound side of the piston.

### 2. BACKGROUND OF THE INVENTION

Shock absorbers are widely used in the suspension systems of recreational vehicles such as snowmobiles and all terrain vehicle vehicles. Shock absorbers dampen shocks experienced when the recreational vehicle travels over rough terrain. Shock absorbers are typically mounted between a vehicle component that moves in relation to the chassis and the chassis itself. Shock absorbers are often used in combination with a spring assembly which may or may not be integrated with the shock absorber. In a snowmobile, shock absorbers are typically positioned between the chassis and the slide frame around which an endless track rotates to propel the vehicle. The shock absorber(s) allow the slide frame or the ski, when used on a snowmobile, to compress towards the chassis at a controlled rate. In the case of an all terrain vehicle, the shock absorbers are typically positioned between a wheel assembly and the chassis. The shock absorber(s) allow the wheel assembly to compress towards the chassis at a controlled rate.

Shock absorbers typically have a shock body having a cylindrical wall sealed between first and second end caps creating a cavity in which a fluid is contained. The interior of the shock body is separated into two sections by a piston, which moves within the fluid. Shock absorbers typically include a shock rod having a first end attached to the moveable vehicle component, defining a shock rod/piston assembly, and a second end attached to the vehicle frame or chassis. Normally the shock rod is attached to the vehicle chassis through a rod eye. The first end cap, which is typically at the bottom of the shock body includes a mounting structure suitable for coupling to a vehicle component that moves in relation to the chassis. In the case of a rear suspension system of a snowmobile, the end cap is coupled to the slide frame. In the case of an all terrain vehicle, the end cap is coupled to a frame component. The shock rod extends through the second end cap of the shock body which is named the “rod-eye end cap.” The rod-eye end cap is typically disposed at the top of the shock body.

For the piston to move within the shock body, the fluid within the fluid-filled cavity of the shock body must travel through the piston. Therefore, passages are formed through the piston to control the fluid flow between each section of the shock body. The passages are typically aligned with the longitudinal axis of the piston. The openings of some of these passages may be covered with leaf valves while the remainder of the openings may be uncovered to thus serve as by-pass passages. The only restriction in the by-pass passages is the viscosity of the fluid itself and the diameter of the passages.

The shock rod/piston assembly and the shock body (which includes the cylindrical wall and both of the end caps) move in relation to one another upon the application of forces to the shock absorber. The relative movement between the shock rod/piston assembly and the shock body results in the movement of the piston through the fluid, which provides the hydraulic damping for the shock absorber. Therefore, the shock forces that are applied to the vehicle component, to which the shock absorber is coupled, are at least partially absorbed by the shock absorber. Accordingly, the shock forces that are applied to the vehicle frame or chassis are dissipated by the shock absorber.

The movement of the shock rod/piston assembly within the fluid-filled cavity of the shock body occurs in two stages, a compression stage followed by a rebound stage both of which are described in greater detail below.

As the vehicle travels over rough terrain, shock forces are applied to the vehicle component to which the shock absorber is mounted. These shock forces cause the vehicle component to move from a steady state position to a position where the vehicle component has compressed relative to the chassis. Since the shock absorber is disposed between the vehicle component and chassis, as the component and the chassis move toward one another, the shock absorber compresses. This is called the compression stage. As the shock absorber compresses, the shock rod/piston assembly moves inwardly relative to the shock body, within the fluid-filled cavity of the shock body. As a result, the piston moves within the fluid-filled cavity of the shock body toward the first end cap. During this compression stage, the shock absorber slows or dampens the rate at which the vehicle component compresses toward the chassis.

The rebound stage follows the compression stage. The rebound stage results from the resilient expansion of the spring associated with the shock absorber, which pushes the vehicle component away from the vehicle chassis to the original steady state position. The force exerted by the spring is usually quite low by comparison with the compressive force, because, in the rebound stage, the force of the spring only needs to be high enough to overcome the combined weight of the vehicle and the rider. This spring force causes the shock absorber to extend, resulting in the shock rod/piston assembly extending outwardly relative to the shock body. The piston moves within the fluid-filled cavity away from the first end cap toward the second or “rod eye” end cap. As was the case during the compression stage, the shock absorber slows or dampens the rate at which the vehicle component may move relative to the chassis during the rebound stage.

During the compression stage, the shock rod/piston assembly moves inwardly within the shock body toward the shock body first end cap. Accordingly, the shock rod displaces a volume of fluid within the shock body that is equal to the volume of the shock rod that has extended into the shock body. To accommodate this displacement of fluid, a reservoir including a gas chamber is typically used in association with the shock absorber. As fluid is displaced by the shock rod, the volume of the gas chamber decreases by an amount that is equal to the volume of the shock rod entering the shock body. The gas chamber is filled with a pressurized gas such as nitrogen, which compresses to accommodate the fluid.

Existing shock absorbers are typically of two different designs. In a first shock absorber design, the reservoir including the gas chamber may be disposed within the shock body, at a location between the piston and the first end cap. This location between the piston and the first end cap is known as the compression side of the piston. Alternatively, in a second shock absorber design, the reservoir including the gas chamber may be disposed within a separate reservoir body that is in fluid communication with the shock body. In this second shock absorber design, the fluid communication exists through a conduit that connects the reservoir to the shock body. The conduit is attached to the shock body on the compression side of the piston, typically between the piston and the first end cap, or directly to the first end cap. In either of these two shock absorber designs, the gas chamber is typically separated from the fluid by a movable seal typically referred to as a floating seal or the gas is contained in a bladder. The floating seal that separates the gas chamber from the fluid moves as the gas chamber volume decreases or in the case of shock absorber using a bladder, the bladder is compressed to increase the volume in the reservoir for the oil displaced by the shock rod entering the shock body.

During the compression stage, high compression forces may be applied to the shock absorber. These high compression forces may move the shock rod/piston assembly through the fluid at a faster rate than fluid can travel through the piston. Consequently, the piston pushes fluid from the compression side of the piston into the reservoir.

It is known that under the application of high compression forces, the force of the fluid pushed by the piston moves the floating seal a greater amount than if the floating seal were moved only by fluid displaced as a result of the application of a lower force on the shock absorber. In other words, under the application of high compression forces, a volume of fluid enters the reservoir that is greater than the volume of the shock rod entering the shock body. Consequently, in this situation, the piston moves faster than fluid behind the piston accumulates. A decrease in pressure behind the piston results, which allows the fluid behind the piston to vaporize. The vaporization results in cavitation, which deteriorates the piston and also diminishes the performance of the shock absorber. The force applied to the shock absorber at which cavitation occurs is known as the capacity of the shock absorber.

A need, therefor, has developed for a shock absorber that accommodates fluid displacement as the shock rod moves inwardly within the shock body during the compression stage, but does not encourage cavitation during the compression stage. The prior art does not address this deficiency.

### SUMMARY OF THE INVENTION

It is, therefore, an object of the present invention to provide a simple, cost-effective, reliable, shock absorber with improved characteristics.

It is still another object of the present invention to provide a shock absorber that minimizes the possibility of cavitation occurring during the compression stage.

In furtherance of these objects, one aspect of the present invention is to provide a shock absorber having a gas chamber disposed on the rebound side of the piston.

Another aspect of the present invention is to provide a shock absorber having the gas chamber disposed within a top cap.

A further aspect of the present invention is to provide a shock absorber having the gas chamber disposed within a reservoir separated from, but in fluid communication with, a shock body.

Yet another aspect of the present invention is to provide a shock absorber having a shock rod having a longitudinal axis, a first end, and a second end. A shock body is disposed around the first end of the shock rod. The shock body defines a fluid chamber therein and is slidable along the shock rod longitudinal axis. The shock body has a first end and a second end. The shock rod extends through the shock body second end such that the shock rod second end is disposed outside the shock body. A piston is disposed on the first end of the shock rod in sealing engagement with the shock body. The piston has at least one channel therethrough in communication with the fluid chamber. The piston separates the shock body fluid chamber into a first fluid chamber and a second fluid chamber. The first fluid chamber is disposed between the shock body first end and the piston. The second fluid chamber is disposed between the shock body second end and the piston. A reservoir comprising a gas chamber and a movable sealing surface separates the reservoir gas chamber from the shock body second fluid chamber, with which the reservoir is in fluid communication.

The foregoing objects are not meant to limit the scope of the present invention. To the contrary, still other objects of the present invention will become apparent from the description that follows.

### BRIEF DESCRIPTION OF THE DRAWINGS

Reference will be made herein after to the accompanying drawings, which illustrate embodiments of the present invention discussed herein below, wherein:

FIG. 1 is a cross-sectional side view of a first embodiment of a shock absorber constructed in accordance with the teachings of the present invention;

FIG. 2 is a cross-sectional side view of a second embodiment of a shock absorber constructed in accordance with the teachings of the present invention;

FIG. 3 is a cross-sectional side view of a third embodiment of a shock absorber constructed in accordance with the teachings of the present invention;

FIG. 4 is a cross-sectional side view of a fourth embodiment of a shock absorber constructed in accordance with the teachings of the present invention; and

FIG. 5 is a side view of a snowmobile of the present invention, illustrating several possible locations for the embodiments of the shock absorber illustrated in FIGS. 1-4.

### DETAILED DESCRIPTION OF THE PREFERRED EMBODIMENTS

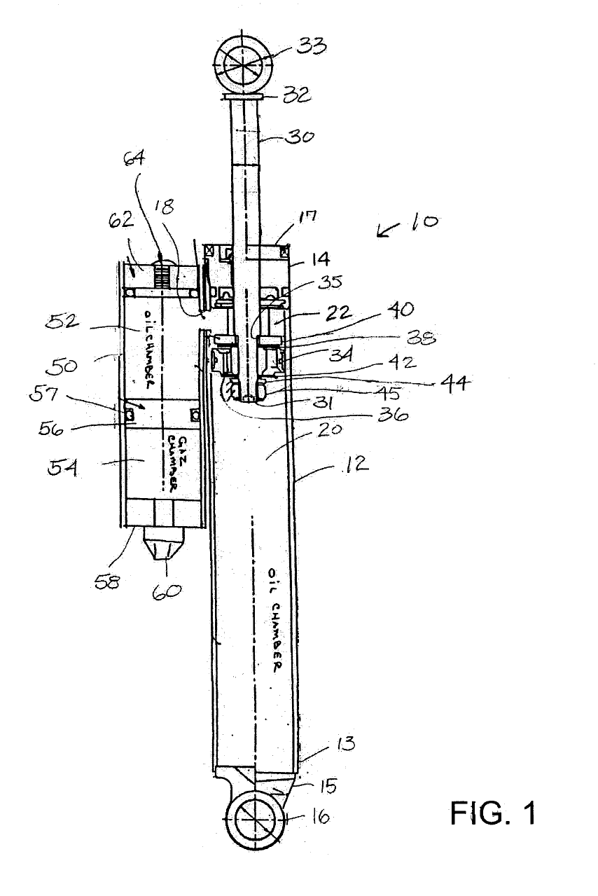

FIG. 1 shows a first embodiment of the shock absorber according to the present invention. In the embodiment illustrated in FIG. 1, the shock absorber 10 includes a shock body 12 defining a fluid chamber therein. The shock body 12 has a cylindrical wall having a first end 13 and a second end 14. A first end cap 15 is disposed at the shock body first end 13. The first end cap 15 includes an eye 16 for attachment to a vehicle component such as a wheel assembly. A second end cap 17 is disposed at the shock body second end 14. The first and second end caps 15, 17 serve to enclose the fluid chamber within the shock body 12.

A shock rod 30 having a longitudinal axis is partially disposed within the shock body 12. The shock rod 30 includes a first end 31 disposed within the shock body 12 and a second end 32 disposed outside the shock body. The shock rod second end 32 includes a rod eye 33, which is typically for attachment to a vehicle chassis. The shock rod first end 31 is slidable within the shock body 12 within a predetermined range, generally between the first end cap 15 and the second end cap 17.

A piston 34 is disposed on the shock rod first end 31. The piston 34 is in sealing engagement with an interior surface of the shock body 12. The piston 34 separates the shock body fluid chamber into a first fluid chamber 20 and a second fluid chamber 22, the first fluid chamber 20 being disposed between the shock body first end cap 15 and the piston 34, the second fluid chamber 22 being disposed between the shock body second end cap 17 and the piston 34. The first fluid chamber 20 is a compression chamber. The second fluid chamber 22 is a rebound chamber.

The piston 34 has at least one channel 36, but preferably a plurality of channels 36, extending therethrough in communication with the first and second fluid chambers 20 and 22. The channels 36 extend entirely through the piston 34 from the piston upper end to the piston lower end. A valve 38 comprising at least one circular disk made of flexible material is preferably disposed adjacent the upper end of the piston 34. A washer 40 is disposed above the valve 38. The washer 40 engages a shoulder 35 on the shock rod 30. A second valve 42, comprising at least one circular disk made of flexible material, is preferably disposed adjacent the lower end of the piston 34. The valves 38, 42 may be referred to as “leaf valves.” It is understood that the valves 38, 42 typically comprise a plurality of individual flexible disks. The valves 38, 42 are constructed to flex when a predetermined amount of pressure is applied thereto. The valves 38, 42 typically cover at least some of the channels 36. The valves 38, 42 serve to control the fluid flow between the first and second fluid chambers 20, 22. A spacer washer 44 is disposed under the second valve 42. A nut 45 serves to retain the washer 40, first valve 38, piston 34, second valve 42, and the spacer washer 44 on the shock rod first end 31.

A reservoir 50 is attached to the shock body 12. The reservoir 50 includes a fluid chamber 52 which is in fluid communication with the second fluid chamber 22 of the shock body 12 through a passage 18. As indicated, the second fluid chamber 22 is the rebound chamber. The reservoir 50 further includes a gas chamber 54 and a movable seal 56 separating the reservoir gas chamber 54 from the reservoir fluid chamber 52. Accordingly, the movable seal 56 separates the reservoir gas chamber 54 from the shock body second fluid chamber 22 with which the reservoir fluid chamber 52 is in fluid communication. The movable seal 56 is also known as a floating piston. An O-ring 57 is preferably disposed within the moveable seal 56.

The reservoir 50 has a peripheral wall that is typically cylindrical in shape. The passage 18, through which fluid communicates between the reservoir fluid chamber 52 and the second fluid chamber 22 of the shock body 12 in this embodiment, comprises adjacent openings which extend through the walls of the reservoir 50 and the shock body 12. A first end cap 58 is disposed at a first end of the reservoir 50. A valve 60, through which pressurized gas may be introduced into the reservoir gas chamber 54, is disposed through the end cap 58. A second end cap 62 is disposed at a second end of the reservoir 50. An oil port 64 is disposed through the second end cap 62.

In use, during the compression stage of the shock absorber 10, the piston 34 and the shock rod 30 move downwardly (the orientation referring to FIG. 1) relative to the shock body 12 toward the shock body first end cap 15. As the piston 34 is in sealing engagement with the inside surface of the shock body 12, the fluid within the shock absorber 10 must pass through the piston channels 36 for the piston 34 to move within the shock body 12. All of the individual flexible disks that comprise the valve 38 must flex to allow the fluid to pass through the channels 36. Accordingly, to move the piston 34 downwardly during this compression stage, a sufficient compression force must be applied to the shock absorber 10 for the fluid in the shock body first fluid chamber 20, which is the compression chamber, to exert a sufficient force on the valve 38 to flex the valve 38 sufficiently to allow the passage of fluid through the channels 36. The piston 34 also encounters resistance from the fluid within the shock body compression chamber 20. This fluid resistance must also be overcome for the piston 34 to move relative to the shock body 12. Also, the compression force applied to the shock absorber 10 must overcome the friction between piston 34 and the inner surface of the shock body 12 for the piston 34 to move relative to the shock body 12.

As the piston 34 and shock rod 30 move toward the shock body first end cap 15 under a compression force, the volume of the shock rod 30 entering the shock body 12 displaces fluid within the shock body 12. The displaced fluid from the shock body 12 enters the reservoir fluid chamber 52 through the passage 18. As the volume of fluid in the reservoir fluid chamber 52 increases, the movable seal 56 moves toward the reservoir first end cap 58 to accommodate this increase in the fluid within the reservoir fluid chamber 52. The volume of the reservoir gas chamber 54 decreases a corresponding amount. The gas within the reservoir gas chamber 54 compresses as the volume within the reservoir gas chamber 54 decreases.

Under a large compression force, the piston 34 and shock rod 30 move toward the shock body first end cap 15 at a faster rate than occurs in response to a small compression force. However, the piston 34 and shock rod 30 move toward the shock body first end cap 15 without causing the piston 34 to push fluid into the reservoir 50, as would be the case in prior art shock absorbers. In the present invention shock absorber 10, as the piston 34 moves toward the shock body first end cap 15 under a large compression force, fluid within the first fluid chamber 20 between the piston 34 and the first end cap 15 cannot be pushed by the piston 34 into the reservoir 50. This is because the first fluid chamber 20 (a.k.a. the compression chamber) is not in direct fluid communication with the reservoir 50. However, a volume of fluid within the shock body 12 equal to the volume of the shock rod 30 entering the shock body 12 under this large compression force will be displaced from the shock body 12 and will enter the reservoir 50. As it turns out, the displaced fluid does not enter the reservoir 50 at a rate which exceeds the rate at which the volume of the shock rod 30 enters the shock body 12. Since the fluid enters the reservoir 50 at the same rate at which the volume of the shock rod 30 enters the shock body 12, there is little likelihood that a vacuum can be created behind the piston 34. Consequently, there is little likelihood that cavitation can occur adjacent to the piston 34 during the compression stage.

A rebound stage follows the aforementioned compression stage of the shock absorber 10. During the rebound stage, a spring (not shown) associated with the shock absorber 10 will resiliently expand. The resiliently expanding spring exerts a force on the shock absorber 10, causing the shock absorber 10 to extend and return to an initial pre-compression position. As was the case during the compression stage, fluid within the shock body 12 must pass through the piston channels 36 for the piston 34 to move within the shock body 12. All of the individual flexible disks that comprise the valve 42 must flex to allow the fluid to pass through the channels 36. The force exerted by the resiliently expanding spring on the shock absorber 10 is considerably less than the individual compression forces acting on the shock absorber 10. Because of this, the piston 34 does not move as rapidly through the shock body 12 during the rebound stage. Consequently, fluid within the rebound chamber 22 passes easily through the valve 44 without a likelihood of causing cavitation.

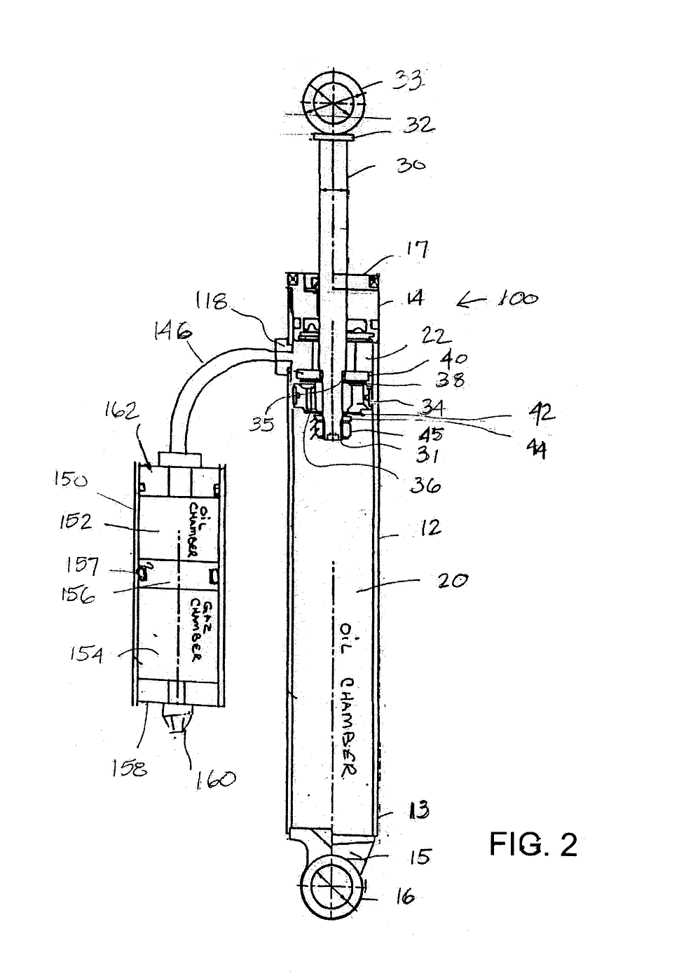

Briefly, FIG. 2 shows a second embodiment of the shock absorber 100 having a shock body 12 and a reservoir 150. The reservoir 150 is in fluid communication with a shock body second fluid chamber 22 (rebound chamber) through a conduit 146 which couples the reservoir 150 to the shock body 12. Elements of the embodiment of the invention illustrated in FIG. 2, which are in common with the embodiment illustrated in FIG. 1 share the same reference numerals.

A reservoir 150 is coupled to the shock body 12. The reservoir 150 includes a fluid chamber 152 which is in fluid communication with the second fluid chamber 22 of the shock body 12 through the conduit 146 which extends from the reservoir 150 to the shock body 12. Once again, the second fluid chamber 22 is the rebound chamber. The reservoir 150 further includes a gas chamber 154 and a movable seal 156 separating the reservoir gas chamber 154 from the reservoir fluid chamber 152. Accordingly, the movable seal 156 separates the reservoir gas chamber 154 from the shock body second fluid chamber, with which the reservoir fluid chamber 152 is in fluid communication. The movable seal 156 is also known as a floating piston.

The reservoir 150 has a peripheral wall that is typically cylindrical in shape. A first end cap 158 is disposed at a first end of the reservoir. A valve 160 through which pressurized gas may be provided to the gas chamber 154 is disposed through the end cap 158. A second end cap 162 is disposed at a second end of the reservoir. The passage through which fluid communicates between the reservoir fluid chamber 152 and the second fluid chamber 22 of the shock body 12 in this embodiment is the conduit 146, which extends from the end cap 162 to the shock body 12 where the conduit attaches via a fitting 118. The conduit could be constructed from a variety of materials and could be flexible or rigid.

The operation of the shock absorber 100 of the second embodiment is substantially the same as the operation previously described for the first embodiment of the shock absorber 10 described in reference to FIG. 1.

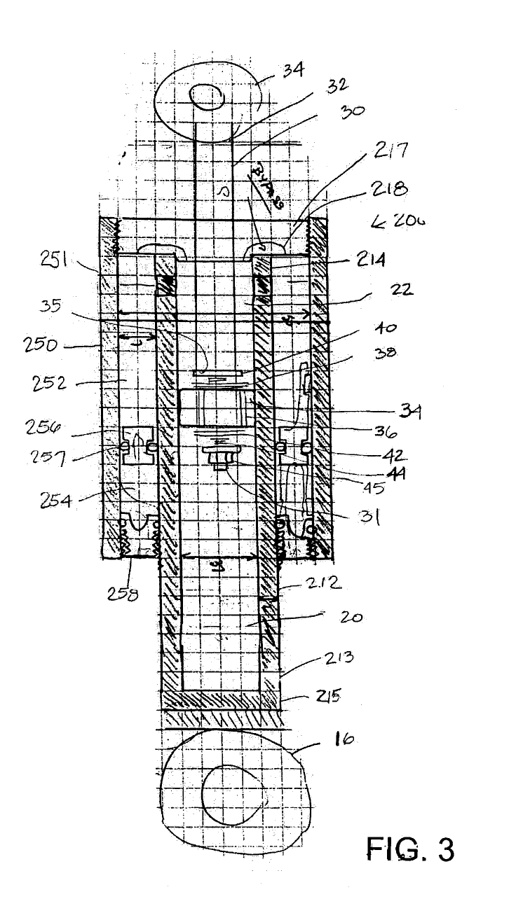

Briefly, FIG. 3 shows a third embodiment of the shock absorber 200 having a shock body 212 and a reservoir 250. The reservoir 250 is in fluid communication with a shock body second fluid chamber 22 (rebound chamber) through a by-pass passage 218, disposed in an end cap 217 which couples the reservoir 250 to the shock body 212. Elements of the embodiment of the invention illustrated in FIG. 3, which are in common with the embodiment illustrated in FIG. 1 share the same reference numerals.

Specifically, in the embodiment illustrated in FIG. 3, the shock absorber includes a shock body 212 defining a fluid chamber therein. The shock body 212 has a cylindrical peripheral wall having a first end 213 and a second end 214. A first end cap 215 is disposed at the shock body first end 213. A second end cap 217 is disposed at the shock body second end 214. The first and second end caps 215, 217 serve to enclose the fluid chamber within the shock body 212.

A reservoir 250 is coupled to the shock body 212. The reservoir 250 includes a fluid chamber 252 which is in fluid communication with the second fluid chamber 22 of the shock body 212 through a passage 218 which extends from the reservoir 250 to the shock body second fluid chamber 22. Once again, the second fluid chamber 22 is the rebound chamber. The reservoir 250 further includes a gas chamber 254 and an annular movable seal 256 separating the reservoir gas chamber 254 from the reservoir fluid chamber 252. Accordingly, the movable seal 256 separates the reservoir gas chamber 254 from the shock body second fluid chamber 22, with which the reservoir fluid chamber 252 is in fluid communication. The movable seal 256 is also known as a floating piston.

The reservoir 250 has a peripheral wall 251 that is cylindrical in shape. The reservoir peripheral wall 251 is disposed around the peripheral wall of the shock body 212 in a spaced relation thereto. Preferably, the reservoir peripheral wall 251 is disposed around the peripheral wall of the shock body 212 in a concentric relationship. A first end cap 258 is disposed at a first end of the reservoir. The first end cap 258 seals the space between the reservoir peripheral wall and the peripheral wall of the shock body 212. A valve (not shown) through which pressurized gas is introduced into the gas chamber 254 may be disposed on the end cap 258. The shock body second end cap 217 is disposed at a second end of the reservoir, and serves to connect the reservoir 250 to the shock body 212. The passage through which fluid communicates between the reservoir fluid chamber 252 and the second fluid chamber 22 of the shock body 212 in this embodiment comprises a passage 218 which extends through (and is defined by) the end cap 217. Passage 218 could also extend through the peripheral wall of the shock body to be independent of end cap 217.

Passage 218 could also be equipped with fluid flow adjusters to restrict the flow entering and exiting the reservoir 250. This enables the user to modify the characteristic of the shock absorber to accommodate different terrain or riding styles.

The operation of the shock absorber 200 of the third embodiment is substantially the same as the operation previously described for the first embodiment of the shock absorber 10 described in reference to FIG. 1, and that of the second embodiment 100 described in reference to FIG. 2.

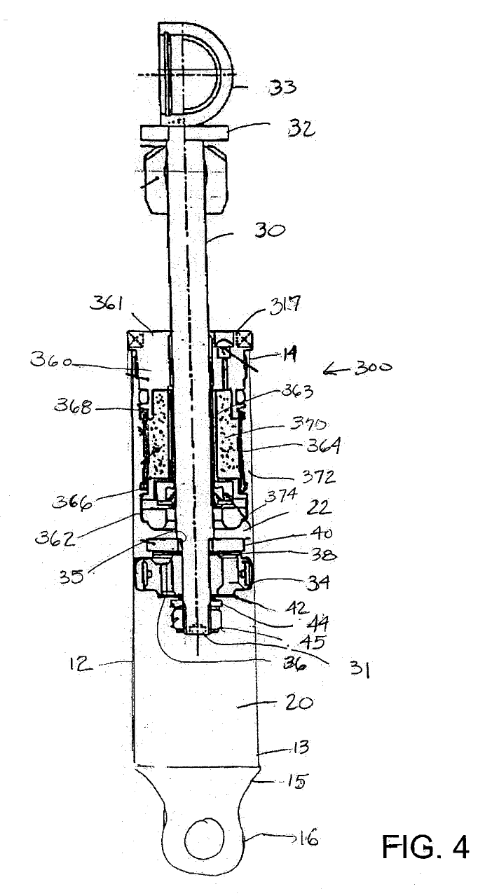

Briefly, FIG. 4 shows a fourth embodiment of the shock absorber 300 having a shock body 12 and a end cap 360. A reservoir gas chamber 370 is integrated into the end cap 360. The reservoir gas chamber 370 is separated from a reservoir fluid chamber 372 by a movable membrane 364. The reservoir fluid chamber 372 is in fluid communication with a shock body second fluid chamber 22 (rebound chamber) through a passage 374, which separates a second end 362 of the end cap 317 from the peripheral wall of the shock body 12. Elements of the embodiment of the invention illustrated in FIG. 4, which are in common with the embodiment illustrated in FIG. 1 share the same reference numerals.

The second end cap 317 includes a body 360 having an external end portion 361 and an internal end portion 362. A conduit or passage 363 extends the length of the body 360. The shock rod 30 is slidably disposed within the passage 363. A flexible sealing membrane 364 having a cylindrical peripheral wall is coupled to the body at a first attachment location 366 proximate to the internal end portion 362, and at a second attachment location 368 proximate to the external end portion 361. The flexible membrane 364, which is a movable sealing surface, extends between the first and second attachment locations 366 and 368 to, thus, seal a reservoir gas chamber 370 within the second end cap 317. For illustrative purposes, a reservoir fluid chamber 372 is defined as the location between the shock body cylindrical peripheral wall and the cylindrical peripheral wall of the flexible membrane 364. For illustrative purposes, a gap 374 separating the internal end portion 362 of the second end cap body 360 from the cylindrical peripheral wall of the shock body 12 defines a passage through which the reservoir fluid chamber 372 is in fluid communication with the second shock body fluid chamber 22 (rebound chamber). It is understood that there is in fact no definite delineation between second shock body fluid chamber 22 and the reservoir fluid chamber 372. It is also understood that this is also true in the previous embodiments. This is because the reservoir fluid chamber is in fluid communication with the second shock body fluid chamber in each of the embodiments of the invention. However, for definitional purposes, a reservoir fluid chamber has been defined for each of these embodiments.

The operation of the shock absorber 300 of the fourth embodiment is substantially similar to the operation previously described for the first embodiment of the shock absorber described in reference to FIG. 1. However, a detailed description of the operation is as follows.

As the piston 34 and shock rod 30 move toward the shock body first end cap 15 under a compression force, the volume of the shock rod 30 entering the shock body 12 displaces fluid within the shock body 12. The displaced fluid from the shock body 12 enters the reservoir fluid chamber 372 through the passage 374. As the volume of fluid in the reservoir fluid chamber 372 increases, the flexible membrane 364 moves inwardly toward the conduit 363 to accommodate this increase in the fluid within the reservoir fluid chamber 372. The volume of the reservoir gas chamber 370 decreases a corresponding amount. The gas within the reservoir gas chamber 370 compresses as the volume within the reservoir gas chamber 370 decreases.

Under a large compression force, the piston 34 and shock rod 30 move toward the shock body first end cap 15 at a faster rate than occurs under a small compression force. However, the piston 34 and shock rod 30 move toward the shock body first end cap 15 without causing the piston to push fluid toward the reservoir fluid chamber 372, as would be the case in prior art shock absorbers. In the present invention shock absorber 300, as the piston 34 moves toward the shock body first end cap 15 under a large compression force, fluid within the first fluid chamber 20, between the piston 34 and the first end cap 15, cannot be pushed by the piston 34 toward the reservoir fluid chamber 372. This is because the first fluid chamber 20 (a.k.a. the compression chamber) is not in direct fluid communication with the reservoir fluid chamber 372. However, a volume of fluid within the shock body 12 equal to the volume of the shock rod 30 entering the shock body 12 under this large compression force will be displaced from the shock body 12 and will enter the reservoir fluid chamber 372. But, the displaced fluid will not enter the reservoir fluid chamber 372 at a rate which exceeds the rate at which the volume of the shock rod 30 enters the shock body 12. As the fluid entering the reservoir fluid chamber 372 at the same rate at which the volume of the shock rod 30 enters the shock body 12, there is little likelihood that a vacuum can occur behind the piston 34 and that cavitation can occur adjacent to the piston 34 during the compression stage.

A rebound stage follows the aforementioned compression stage of the shock absorber. During the rebound stage, a spring associated with the shock absorber (not shown) will resiliently expand. The resiliently expanding spring exerts a force on the shock absorber 300 causing the shock absorber 300 to extend and return to an initial pre-compression position. As was the case during the compression stage, fluid within the shock body must pass through the piston channels 36 for the piston 34 to move within the shock body 12. All of the individual flexible disks that comprise the valve 42 must flex to allow the fluid to pass through the channels 36. The force exerted by the resiliently expanding spring on the shock absorber 300 is considerably less than many compression forces acting on the shock absorber 300. Because of this, the piston 34 does not move as rapidly through the shock body 12 during the rebound stage. Consequently, fluid within the rebound chamber 22 passes easily through the valve 44 without a likelihood that the piston 34 could move fast enough for cavitation to occur.

The shock absorber of the present invention is preferably made from steel or aluminum and has a circular cross-sectional shape. However, as would be known by one skilled in the art, the shock absorber could be made in any shape and from any suitable material(s) capable of withstanding shocks experienced in the environment in which the shock absorber is designed to operate.

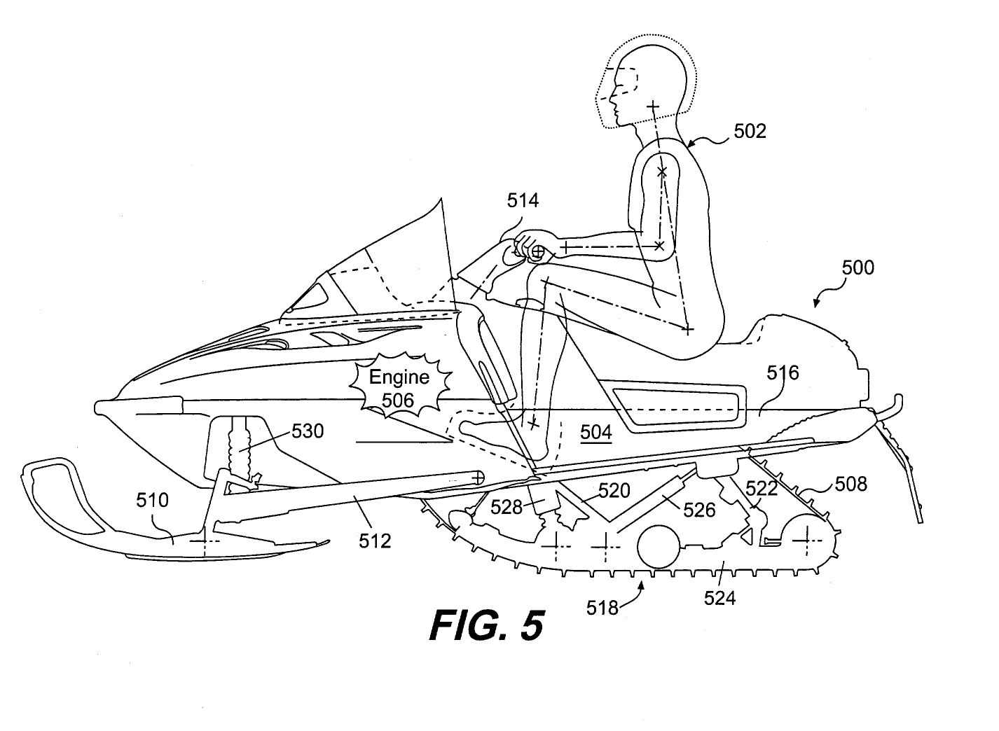

FIG. 5 illustrates a conventional snowmobile 500, in which a rider 502 sits toward the rear of the snowmobile 500. The snowmobile 500 has a frame 504 that supports an engine 506. Frame 504 includes a front engine support (not shown) and a rear tunnel 516 which as an inverted U-shape cross section housing the endless drive track 508 and rear suspension system 518. The engine 506 is positioned forwardly on the snowmobile 500 and is operatively connected to an endless drive track 508 to drive the snowmobile 500. Two steering skis 510 (only one of which are shown) are supported by the frame via a swing arm suspension system. Each steering ski 510 pivots relative to the swing arm suspension system. To comfortably position the handlebar 514 relative to the rider 502, the handlebar 514 is positioned rearwardly of the forwardly disposed engine 506. The handlebar 514 is connected to each ski 510 through a known manner to enable the handlebar 514 to transfer steering forces to the steering skis 510.

Rear suspension system 518 includes, among other things, front suspension arms 520, rear suspension arms 522, slide rails 524, a rear shock absorber 526 and a central shock absorber 528. Rear and central shock absorbers 526, 528 control the movement of the rear suspension system 518 with respect to the frame 504. A set of front shock absorber 530 (only one shown) also controls the movement of the skis 510 with respect to the frame 504. The shock absorbers 10, 100, 200, 300 may be used for any or all of the shock absorbers 526, 528, 530 shown on the snowmobile 500 illustrated in FIG. 5.

While the invention has been described with reference to several preferred embodiments, it will be understood by those skilled in the art that various changes may be made and equivalents may be substituted for elements thereof without departing from the spirit and scope of the present invention. In addition, many modifications may be made to adapt a particular situation, component, or material to the teachings of the present invention without departing from its teachings as claimed.

What is claimed is:

1. A shock absorber, comprising:
a shock rod having a longitudinal axis, a first end, and a second end;
a shock body disposed around the first end of the shock rod, the shock body defining a fluid chamber therein and being slidable along the shock rod longitudinal axis, the shock body having a first end and a second end, the shock rod extending through the shock body second end such that the shock rod second end is disposed outside the shock body;
a piston disposed on the first end of the shock rod in sealing engagement with the shock body, the piston having at least one channel therethrough in communication with the fluid chamber, the piston separating the shock body fluid chamber into a first fluid chamber and a second fluid chamber, the first fluid chamber being disposed between the shock body first end and the piston, the second fluid chamber being disposed between the shock body second end and the piston; and
a reservoir comprising an fluid chamber, a gas chamber and a movable sealing surface separating the reservoir fluid chamber from the gas chamber, the fluid chamber being in fluid communication with the shock body second fluid chamber

2. The shock absorber of claim 1, further comprising:
a conduit coupling the reservoir fluid chamber to the shock body, the fluid chamber being in fluid communication with the shock body second fluid chamber through the conduit.

3. The shock absorber of claim 1, wherein the movable sealing surface comprises one of floating piston and a bladder.

4. The shock absorber of claim 1, wherein the shock body includes a peripheral wall, and the reservoir includes a peripheral wall disposed around at least a portion of the shock body peripheral wall, the reservoir being defined by an intervening space between the shock body peripheral wall and the reservoir peripheral wall, the reservoir fluid chamber in fluid communication with the shock body second fluid chamber through a passage.

5. The shock absorber of claim 4, wherein the passage extends through the shock body peripheral wall.

6. The shock absorber of claim 4, further comprising:
an end cap, the end cap sealing the reservoir housing peripheral wall to the shock body peripheral wall, the end cap including at least one conduit therethrough, the reservoir fluid chamber being in fluid communication with the shock body second fluid chamber through the at least one end cap conduit.

7. The shock absorber of claim 1, wherein the movable sealing surface comprises a membrane.

8. The shock absorber of claim 7, wherein the shock body includes an end cap, the end cap including the reservoir gas chamber, and the membrane is attached to the end cap, thus enclosing the reservoir gas chamber within the end cap.

9. The shock absorber of claim 8, wherein the shock body end cap includes a body having an external end portion and an internal end portion, the internal end portion being disposed within the shock body, the reservoir gas chamber being disposed between the external end portion and the internal end portion, the membrane extending between the external end portion to the internal end portion, thereby enclosing the reservoir gas chamber within the end cap.

10. A snowmobile comprising:
an engine;
a frame including a tunnel;
at least two skis operatively connected to the frame for steering the snowmobile;
a drive track below the tunnel operatively connected to the engine;
a rear suspension system connected to the frame supporting the drive track; and
the shock absorber of claim 1, the shock absorber being attached to the frame and to one of the skis and the rear suspension system.

11. The snowmobile of claim 10, wherein the shock body includes a peripheral wall, and the reservoir includes a peripheral wall disposed around at least a portion of the shock body peripheral wall, the reservoir being defined by an intervening space between the shock body peripheral wall and the reservoir peripheral wall, the reservoir fluid chamber in fluid communication with the shock body second fluid chamber through a passage.

12. The snowmobile of claim 11, wherein the passage extends through the shock body peripheral wall.

13. The snowmobile of claim 11, further comprising:
an end cap, the end cap sealing the reservoir housing peripheral wall to the shock body peripheral wall, the end cap including at least one conduit therethrough, the reservoir fluid chamber being in fluid communication with the shock body second fluid chamber through the at least one end cap conduit.

14. The snowmobile of claim 10, wherein the movable sealing surface comprises a membrane.

15. The shock absorber of claim 14, wherein the shock body includes an end cap, the end cap including the reservoir gas chamber, and
the membrane is attached to the end cap, thus enclosing the reservoir gas chamber within the end cap.

16. The shock absorber of claim 15, wherein the shock body end cap includes a body having an external end portion and an internal end portion, the internal end portion being disposed within the shock body, the reservoir gas chamber being disposed between the external end portion and the internal end portion, the membrane extending between the external end portion to the internal end portion, thereby enclosing the reservoir gas chamber within the end cap.

17. The shock absorber of claim 1 wherein the gas chamber is positioned within the shock body between the shock body second end and the piston.
